(19) United States
(12) Patent Application Publication
(10) Pub. No.: US 2021/0257719 A1
(43) Pub. Date: Aug. 19, 2021

(54) LIGHTING POLE WITH INTEGRATED ANTENNA

(71) Applicant: SIGNIFY HOLDING B.V., EINDHOVEN (NL)

(72) Inventors: Alouisius Johannes Gerardus Maria WILLEMSE, EINDHOVEN (NL); Ay Ling DE GOEDEREN-OEI, EINDHOVEN (NL); John Stewart WILSON, EINDHOVEN (NL); Kun WANG, EINDHOVEN (NL)

(73) Assignee: SIGNIFY HOLDING B.V., EINDHOVEN (NL)

(21) Appl. No.: 16/973,355

(22) PCT Filed: Jun. 25, 2019
(86) PCT No.: PCT/EP2019/066877

§ 371 Date: Dec. 8, 2020

(30) Foreign Application Priority Data
Jun. 28, 2018 (EP) 18180539.1

(51) Int. Cl. H01Q 1/24; F21S 8/08; F21V 23/00; H01Q 1/12; H01Q 1/44

(52) U.S. Cl. CPC H01Q 1/246; F21S 8/088; H01Q 1/44; H01Q 1/1242; F21V 23/001

(57) ABSTRACT

The present disclosure provides a lighting pole (100), including a luminaire (110), a structural support element (120) which extends in a longitudinal direction and which is adapted to support the luminaire, and at least one antenna (130) which has a tubular shape and which is arranged such that it extends in the longitudinal direction around the structural support element.

### TECHNICAL FIELD

The present disclosure relates to the field of lighting poles. In particular, the present disclosure relates to a lighting pole having at least one integrated antenna.

### BACKGROUND

With an increasing demand for wireless data traffic and e.g. broadband coverage, both for cellular traffic but also for an increasing number of wirelessly connected internet-of-things (IOT) devices, providers of the necessary infrastructure may be challenged to provide a sufficient antenna density. Especially in urban areas, the physical space available for new cell sites and antenna installations may be limited, and the competition for such available space may be large and the prices may be high.

By co-locating antennas together with other urban infrastructure, such as for example lighting poles, the problem of having to find more physical space may at least partially be avoided. Currently available installations which offer combined lighting poles and antennas may however be bulky, less aesthetically appealing and not very flexible. There is therefore a need for an improved way of providing antennas together with lighting poles.

US2011/156984A1 discloses a lighting pole having a plurality of antennae extending around a vertical member in a longitudinal direction.

### SUMMARY

To at least partially fulfill the above needs, the present disclosure seeks to provide an improved way of integrating antennas with lighting poles. To achieve this, a lighting pole as defined in the independent claim is provided. Further embodiments of the present disclosure are provided in the dependent claims.

According to one aspect of the present disclosure, a lighting pole is provided. The lighting pole may include a luminaire, an internal structural support element extending in a longitudinal direction and adapted to support the luminaire (e.g. over ground), and at least one antenna having a tubular shape and arranged extending in the longitudinal direction around the structural support element.

The lighting pole may for example be a street light, a park light or similar. The at least one antenna may for example be a cellular antenna, an antenna for broadband connectivity, an antenna for IOT, or similar. Providing the at least one antenna around the structural support element may provide an integrated design which do not add to the bulk shape of the lighting pole. When the lighting pole is installed, the luminaire (e.g. a lighting fixture, in which a lighting source may be installed) may be supported by the structural support element and the exact position of the antenna may be varied along the structural support element. The at least one antenna may for example be integrated below the luminaire, and extra antennas may be added without affecting the support of the luminaire.

The tubular shaped antenna has a circumferential, hollow wall having an inside surface formed by an inner wall, and an outside surface formed by an outer wall, the inside surface forming the wall of a hollow core. Between said inner wall and said outer wall a wall cavity is formed, accommodating parts of the antenna. The structural support element extends through said hollow core, hence an outside of the structural support element facing the inside surface (hence inner wall) of the tubular shaped antenna.

The lighting pole is such that the at least one antenna includes at least a first antenna and a second antenna. Both the first antenna and the second antenna may have a tubular shape, and the first antenna and the second antenna may be arranged in a stack (i.e. such that they are positioned one after another) and both extend in the longitudinal direction around the structural support element. The lighting pole may further include at least one radio cable which may be connected in one end to the second antenna and routed through a routing space provided between an outside of the structural support element and an inside surface of the first antenna. Here, it is envisaged that when the lighting pole is installed e.g. on ground, the second antenna is above the first antenna. By using the routing space available between the structural support element and the first antenna, the cable (or cables) for the second antenna may be routed such that they are hidden from the outside, and without having to use e.g. other spaces where other cables (for e.g. lighting power or IOT data) may be present. Likewise, there may be a similar routing space provided between the structural support element and the second antenna. If more than two antennas are included, cables for e.g. a third antenna located above the second antenna may be routed first through the routing space at the first antenna, and then also through the routing space at the second antenna, and so on and so forth.

In some embodiments, the structural support element may be a pole or tube. The structural support element may for example be made of metal (such as for example steel, or any other suitable metal), and/or a composite material such as glass fiber or carbon fiber. It is envisaged also that the structural support element may for example be made from other suitable materials, as long as enough rigidity is provided to support the luminaire and to withstand e.g. wind or other forces which may act on the lighting pole.

In some embodiments, when the lighting pole is in an installed state (i.e. when the lighting pole is installed to e.g. the ground), a majority (or all) of the weight of the luminaire may be carried by the structural support element. Consequently, little or no weight of the luminaire may be carried by the at least one antenna. As the at least one antenna does not form part of the structural support element, extra antennas may for example be added, and enough structural strength to support e.g. long arms and/or heavy luminaires may still be provided by the structural support element without putting e.g. extra load on the at least one antenna.

In some embodiments, the lighting pole may further include a cable routing element arranged around the structural support element within the routing space (e.g. at the first and/or second antenna) and adapted to support the at least one radio cable. The routing element may be shaped like a tube or e.g. a sleeve, and may for example provide slots/grooves on its outside in which one or more cables may be arranged/guided, to provide a tidy installation of the cables within the routing space(s). If more than one routing space is provided, it is envisaged that such cable routing elements may be provided in each available routing space.

During installation of the lighting pole, it is envisaged that for example the cables may first be arranged within the cable routing element. The routing element and cables may then be fitted inside the corresponding antenna (or vice versa). Once all cables and all necessary cable routing elements are properly arranged, and fitted within corresponding antennas, the structural support element may finally be inserted through the cable routing element and the antennas. It is envisaged also that the cable(s) may be pre-assembled before mounting, and fitted with one or more connectors for the antenna(s).

In some embodiments, the cable routing elements(s) may be an integrated part of the structural support element. The cable routing element part(s) of the structural support element may for example extend along the full length of the structural support element, or be present e.g. only where cables are or will be provided. Integrating the cable routing element(s) into the structural support element may for example increase a diameter of the structural support element, which in turn may provide an increased rigidity/stiffness and less bending of the antenna(s) due to e.g. external forces acting on the lighting pole.

In some embodiments, a distance between the outside of the structural support element and the inside surface of the first antenna (and/or the second, and/or additional, antenna(s) if required), in a direction perpendicular to the longitudinal direction of the structural support element, may be for example between 20 to 150 mm. By providing a sufficient distance, the corresponding routing space may be large enough to serve as a “bending space”. Phrased differently, if the lighting pole is acted upon by external forces (from e.g. wind), the structural support element may bend within the routing space (or “bending space”) without hitting the inner surface of the antenna(s), and thereby avoid damaging the antennas. In some embodiments, for example if one or more cable routing element is provided as integrated part(s) of the structural support element, it is envisaged that the distance may be as small as 0 mm (e.g. between 0 to 150 mm).

In some embodiments, the lighting pole may further include at least one power cable. The at least one power cable may be connected in one end to the luminaire (and/or to a lighting source provided in the luminaire) and be routed through an inside of the structural support element. By routing cables for power and cables for the antennas (i.e. RF cables) through separate spaces, effects of e.g. interference and similar may be avoided or at least reduced.

In some embodiments, the lighting pole may further include at least one mounting bracket with which the at least one antenna may be mounted to the structural support element. The mounting bracket(s) may for example reduce stress on the antennas when mounted to the structural support element, and provide sufficient distance between antennas such that e.g. installation and/or service of connections and cables may be made easier, and such that bending of the structural support element may have a reduced influence on the antennas.

In some embodiments, an outside of the at least one antenna may form part of an outside of the lighting pole. Phrased differently, the antennas may be integrated such that they are “camouflaged” from the outside, which may make the lighting pole more visually/aesthetically appealing. Herein, it is envisaged that the antennas may for example be covered with a “radome” material which may be visually similar to a material of the rest of the lighting pole.

In some embodiments, the lighting pole may further include a base which may be adapted for mounting the lighting pole to ground. The lighting pole may further include a mid-pole section mounted on the base, and extending along the longitudinal direction towards the at least one antenna and the structural support element. The structural support element may extend at least between the mid-pole section and the luminaire.

In some embodiments, the structural support element may extend through the mid-pole section and at least partly through the base. In these or other embodiments, cables (such as cables for the luminaire and/or the antenna, or IOT data cables) may be routed also through mid-pole section and the base and for example down into one or more channels/conduits in ground.

In some embodiments, the lighting pole may include at least one internet-of-things (IOT) space adapted to receive an IOT device.

In some embodiments, the lighting pole may include at least one data cable having an end which terminates in one end in the at least one IOT space, and which is routed through the inside of the structural support element. Like for the power cable to the luminaire (if available), routing of power and data cables separately from RF antenna cables may e.g. reduce interference.

In some embodiments, an outside of the at least one IOT space may form part of an outside of the lighting pole. This may further improve the visual/aesthetical appeal of the lighting pole, and help to “camouflage” also the IOT space from the outside.

The present disclosure relates to all possible combinations of features recited in the claims. Further objects and advantages of the various embodiments of the present disclosure will be described below by means of one or more exemplifying embodiments.

### BRIEF DESCRIPTION OF THE DRAWINGS

Exemplifying embodiments will be described below with reference to the accompanying drawings, in which:

FIG. 1 illustrates schematically an embodiment of a lighting pole according to the present disclosure;

FIGS. 2a and 2b illustrate schematically details of a structural support element and antennas provided in an embodiment of a lighting pole according to the present disclosure;

FIGS. 3a, 3b and 3c illustrate schematically cable routing elements provided in various embodiments of a lighting pole according to the present disclosure; and

FIGS. 4a, 4b and 4c illustrate schematically mounting brackets provided in various embodiments of a lighting pole according to the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested. As illustrated in the figures, the sizes of elements and regions may not necessarily be drawn to scale and may e.g. be exaggerated for illustrative purposes and, thus, are provided to illustrate the general structures of the embodiments.

### DETAILED DESCRIPTION

Exemplifying embodiments will now be described more fully hereinafter with reference to the accompanying drawings. The drawings show currently preferred embodiments, but the invention may, however, be embodied in many different forms and should not be construed as limited to the embodiments set forth herein; rather, these embodiments are provided for thoroughness and completeness, and fully convey the scope of the present disclosure to the skilled person.

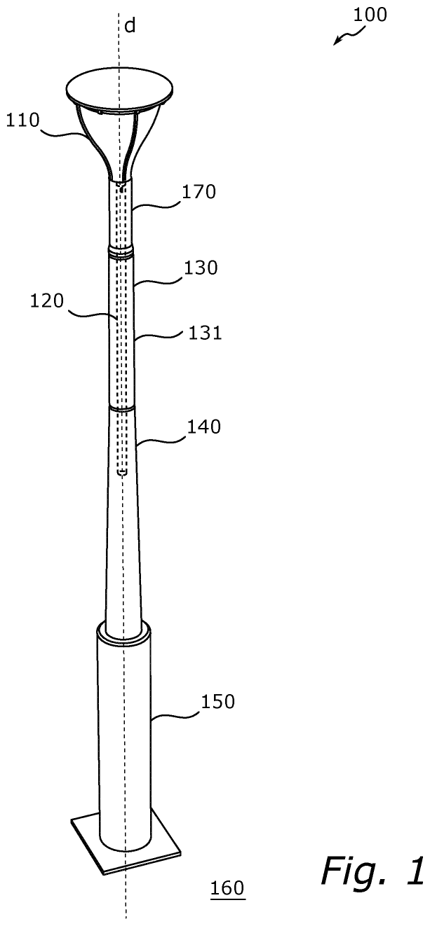

With reference to FIG. 1, a lighting pole according to the present disclosure will now be described in more detail.

FIG. 1 illustrates an embodiment of a lighting pole 100. The lighting pole 100 includes a luminaire 110, a structural support element 120 and an antenna 130. The structural support element 120 extends in a longitudinal direction d (as indicated by the dashed line) and supports the luminaire 110. The antenna 130 has a tubular shape with an, extends along the longitudinal direction d and is arranged around the structural support element 120.

The lighting pole 100 further includes a mid-pole section 140 and a base 150 which is mounted, or may be mounted, to a ground 160. The structural support element 120 may carry the weight of the luminaire 110, such that no or little load is applied on the antenna 130. Although the lighting pole 100 in the embodiment shown in FIG. 1 is illustrated as having a single luminaire 110, it is envisaged that a lighting pole according to the present disclosure may include more than one luminaire. The structural support element may be adapted to carry the weight of all luminaires, such that no or little load is applied to the antenna also in such a situation.

In some embodiments of the lighting pole, the mid-pole section 140 may be optional. It may, for example, be envisaged that the antenna (or several antennas) and the structural support element replaces the mid-pole section and extends all the way down to the base. In some embodiments, it is envisaged that the base is also optional, or at least that the base is an integrated part of the structural support element, such that the structural support element may be mounted e.g. directly to ground, a roof-top, a fence, or other structures on which the lighting pole may be installed.

In the embodiment illustrated in FIG. 1, the structural support element 120 extends between the luminaire 110 and the mid-pole section 140. It may be envisaged also that the structural support element 120 has a different range of extension, such as for example from the luminaire 110, through the mid-pole section 140 and at least partly through the base 150. The extension of the structural support element 120 may be tailored to environmental conditions, such as for example expected wind-strength, or to for example the weight of the one or more supported luminaires.

In the embodiment illustrated in FIG. 1, the lighting pole 100 further includes a space 170 adapted to receive (or including) one or more internet-of-things (IOT) devices. The IOT space 170 may, of course, be optional. If the IOT space 170 is provided, it may be envisaged that the structural support element extends through the IOT space 170 to the luminaire 110, but also that the structural support element extends only to the IOT space 170, and that, in such a case, the IOT space 170 is designed to support the luminaire(s) 110 and e.g. transfer the force to the structural support element.

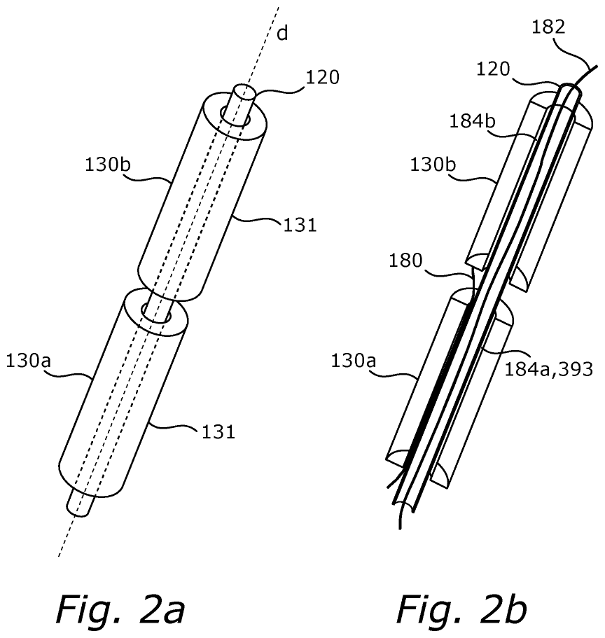

The outside or outer wall 131 (also shown in FIG. 2a) of the antenna 120 forms part of the outside surface of the lighting pole 100, such that the antenna is not visible, or at least less visually apparent from the outside. It is envisaged that the outside of the antenna itself may be similar (in terms of visual appearance) to the rest of the outside material of the lighting pole, but also that an additional layer (such as a “radome” material) may be provided as part of the antenna in order to camouflage the antenna. Such an additional layer may also protect the antenna from the environment, and may for example be tailored in terms of radio frequency attenuation and similar.

With reference to FIGS. 2a and 2b, a structural support element and at least one antenna in a lighting pole according to the present disclosure will now be described in more detail.

FIG. 2a illustrates schematically a structural support element 120 which extends along a longitudinal direction d and at least one antenna. The structural support element 120 is shaped like a rod, but it is envisaged also that the structural support element 120 may have other forms, such as a square rod, a triangular rod, an oval rod or similar. In the embodiment illustrated in FIG. 2a, the at least one antenna includes a first antenna 130a and a second antenna 130b. Both of the first antenna 130a and the second antenna 130b has a tubular shape, and the antennas 130a and 130b are arranged in a stack and such that they surround the structural support element 120. Phrased differently, the structural support element 120 is arranged within the tubular antennas 130a and 130b. Although illustrated in FIG. 2a as two antennas 130a and 130b, it is envisaged that the at least one antenna may include also more than two antennas, and that the antennas may not necessarily be equal but have different forms, functions and complexity.

FIG. 2b illustrates a cross-section of the structural support element 120 and the two antennas 130a and 130b. A first routing space 184a is provided between an outside of the structural support element 120 and an inside surface of the first antenna 130a. Likewise, a second routing space 184b is provided between an outside of the structural support element 120 and an inside surface of the second antenna 130b. A radio cable 180 is routed through the first routing space 184a of the first antenna 130a, and is connected in one end to the second antenna 130b. In this way, the connection to the second antenna 130b (which is arranged above the first antenna 130a) may be provided without being visible from the outside and e.g. in a separate space where no other cables (such as for power or data) are also routed.

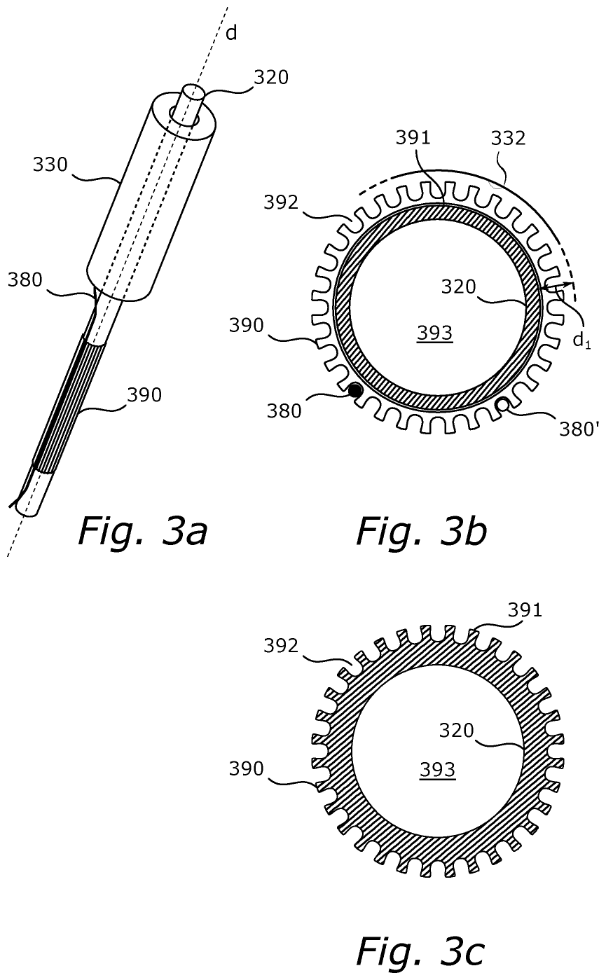

The structural support element 120 is shaped like a hollow rod (e.g. as a cylinder) and has an internal space. A power cable 182 is routed through this internal space, i.e. through an inside 393, (shown in more detail in FIGS. 3b and 3c of the structural support element 120. The power cable 182 may in one end be connected to one or more luminaires (not shown) supported by the structural support element 120. The ends of the radio cable 180 and the power cable 182 not connected to e.g. an antenna or a luminaire may for example continue down (e.g. through a base, if available) towards ground within the lighting pole. It is of course envisaged that more than one cable for each antenna may be required, and that more than one cable for each antenna may be routed through the routing spaces if necessary.

Although the embodiment illustrated in FIG. 2b has two antennas, it is envisaged also that more than two antennas may be used. If, for example, a third antenna is provided above the second antenna 130b, a radio cable for this third antenna may for example be routed through the first routing space 184a of the first antenna 130a, and also through the second routing space 184b of the second antenna 130b, and then be connected to the third antenna. If additional antennas are provided, it may be envisaged, in a similar way, that a cable for a particular antenna may be routed through the routing spaces of the antennas provided below this particular antenna.

The spacing between antennas may be adapted such that cables may easily be connected, such that one or more mounting brackets (as will be described later herein) may be fitted, and with regards to e.g. environmental conditions.

With reference to FIGS. 3a, 3b and 3c, cable routing elements in various embodiments of a lighting pole according to the present disclosure will now be described in more detail.

FIG. 3a illustrates schematically an embodiment including a structural support element 320 extending along a longitudinal direction d, and an antenna 330 which also extends along the longitudinal direction d and which is arranged around the structural support element 320. In the embodiment shown in FIG. 3a, it is assumed that an additional antenna (not shown) is to be included below the antenna 330. A cable routing element 390 is provided and arranged around the structural support element 320. Once the additional antenna is included, the cable routing element 390 will be located within the routing space provided between the additional antenna and the structural support element 320. The cable routing element 390 is adapted to support a radio cable 380, which is routed through the routing space of the additional antenna and connected in on end to the antenna 330 above the additional antenna. The cable routing element 390 may for example be created out of a plastic material or a metal, and produced using for example extrusion or other suitable molding/shaping techniques. It is envisaged also that the cable routing element 390 may be created out of a composite material, such as for example glass and/or carbon fiber.

FIG. 3b illustrates in more detail an embodiment of a non-integrated combination of the cable routing element 390 and the structural support element 320 as seen in a cross-sectional view along the longitudinal direction d. The cable routing element 390 has one or more slots/grooves 392 in which cables 380 and 380′ may be supported. The different slots 392 may together support multiple cables, and the cables may belong to the same or to different antennas. For example, the cable 380 may be a cable for the antenna 330, while the cable 380′ may be a cable for another antenna, but which is also routed through the same routing space as the cable 380. The slots/grooves 392 may extend along the longitudinal direction of the cable routing element 390 and/or the structural support element 320.

A distance d₁ between the outside of the structural support element 320 and an inside surface 332 of an antenna (e.g. the antenna 330, and/or e.g. the first antenna 130a in the embodiment illustrated in FIG. 2a), in a direction perpendicular to the longitudinal direction d, may be provided sufficiently large such that the structural support element may bend without impacting the inner/inside surface 332. Said inside surface 332 is formed by an inner wall of the tubular shaped antenna and faces an outside 391 of the structural support element 320. The distance d₁ may for example be between 20 to 150 mm, but it is envisaged also that other distances may apply, depending for example on the expected environmental conditions (such as wind speed), the height of the lighting pole, the weight of the lighting pole, the weight of the supported luminaire(s), the type of antennas, the size of the cables which are to be routed through the one or more routing spaces, etc.

FIG. 3c illustrates another embodiment, wherein the cable routing element 390 is an integrated part of the structural support element 320. The slots/grooves 392 of the cable routing element 390 may extend along the full length of the structural support element 320, although it is envisaged also that the slots/grooves 392 may be present only when needed, i.e. only along the parts of the structural support element 320 where cables are routed. As described earlier herein, providing the cable routing element 390 as an integrated part of the structural support element 320 may allow for an increased diameter of the structural support element 320, resulting in an increased stiffness/rigidity and a reduced bending of the structural support element 320 (and the antenna(s)) due to e.g. strong wind. In the embodiment illustrated in FIG. 3c, it may be envisaged that the above distance d₁ is as small as 0 mm, i.e. such that there is no distance between the outer edge of the cable routing element/structural support element, i.e. outside 391, and the inside surface 332 of the surrounding antenna(s).

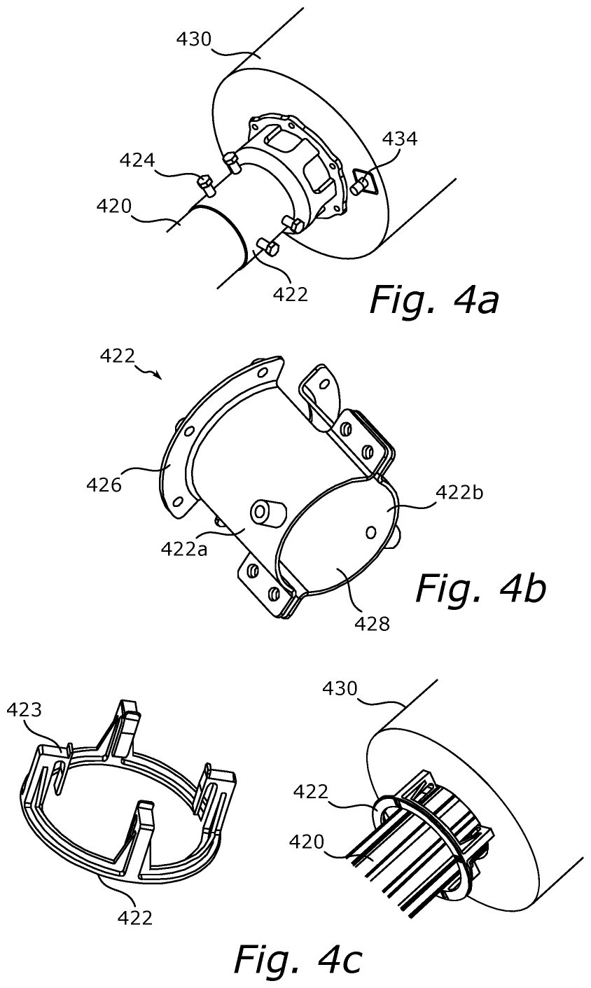

With reference to FIGS. 4a, 4b and 4c, mounting brackets in various embodiments of a lighting pole according to the present disclosure will be explained in more detail.

FIG. 4a illustrates schematically an embodiment including a mounting bracket 422 with which the antenna 430 is mounted to the structural support element 420. The mounting bracket 422 may for example be fastened using one or more bolts/screws 424, but it is envisaged also that other fastening means may be provided instead, or in addition. The mounting bracket 422 may for example provide a distance between adjacent antennas, and provide a mounting of the antenna(s) on the structural support element such that a bending of the structural support element has no or little impact on the antennas themselves. It is of course envisaged also that more than one mounting bracket may be provided, especially if more than one antenna is included in the lighting pole.

Illustrated in FIG. 4a is also a radio port 434 on the antenna 430, at which for example a radio cable may be connected to the antenna 430. It is envisaged, of course, that the antenna 430 (and other antennas described herein) may include more than one radio port.

FIG. 4b illustrates schematically another embodiment wherein the mounting bracket 422 includes a first part 422a and a second part 422b. The structural support element (not shown) may be inserted in an opening 428 between the two parts 422a and 422b, and fastened therein by clamping the two parts 422a and 422b together. As illustrated for the mounting bracket 422 in FIG. 4a, the mounting bracket 422 illustrated in FIG. 4b may be attached to the antenna 430 at for example a flange 426 formed by the two parts 422a and 422b.

FIG. 4c illustrates schematically another embodiment wherein the mounting bracket 422 includes a plurality of distance elements 423. When used to mount the structural support element 420 to the antenna (as illustrated on the left side of FIG. 4c), the mounting bracket 422 may secure the structural support element at a distance from e.g. the circumference of the opening of the tubular shaped antenna. As may be seen from FIG. 4c, and as described earlier herein, the structural support element 420 may include a cable routing element (which may be integrated as a part of the structural support element 420), including a plurality of grooves/slots in which cables for the antennas may be guided/supported.

By providing the structural support element within the antennas, the lighting pole of the present disclosure may offer a more flexible way of co-locating antennas with lighting poles. The structural support element may support the luminaire(s) of the lighting pole, such that no or little weight of the luminaire(s) is carried by the antennas. This may allow for one or multiple luminaires to be carried without having to adapt the shape/structural strength of the antennas, which in turn may offer a broader range of suitable antennas which may be integrated within the lighting pole.

Although features and elements are described above in particular combinations, each feature or element may be used alone without the other features and elements or in various combinations with or without other features and elements.

Additionally, variations to the disclosed embodiments can be understood and effected by the skilled person in practicing the claimed invention, from a study of the drawings, the disclosure, and the appended claims. In the claims, the word “comprising” does not exclude other elements, and the indefinite article “a” or “an” does not exclude a plurality. The mere fact that certain features are recited in mutually different dependent claims does not indicate that a combination of these features cannot be used to advantage.

1. A lighting pole, comprising:
a luminaire;
an internal structural support element extending in a longitudinal direction and adapted to support the luminaire; and
at least one antenna having a tubular shape and arranged extending in the longitudinal direction around said structural support element,
wherein said at least one antenna comprises at least a first antenna and a second antenna both having a tubular shape, arranged in a stack and both extending in the longitudinal direction around said structural support element, and
wherein said lighting pole further comprises at least one radio cable connected in one end to the second antenna and routed through a routing space provided between an outside of the structural support element and an inside surface of the first antenna.

2. The lighting pole of claim 1, wherein said structural support element is a pole or tube made of metal and/or composite material.

3. The lighting pole of claim 1, wherein, when said lighting pole is in an installed state, a majority of the weight of the luminaire is carried by said structural support element.

4. The lighting pole of claim 1, further comprising a cable routing element arranged around said structural support element within said routing space and adapted to support said at least one radio cable.

5. The lighting pole of claim 4, wherein said cable routing element is an integrated part of the structural support element.

6. The lighting pole of claim 4, wherein the cable routing element, has one or more slots and/or grooves.

7. The lighting pole of claim 1, wherein a distance between the outside of the structural support element and the inside surface of the first antenna, in a direction perpendicular to the longitudinal direction of the structural support element, is between 20 to 150 mm.

8. The lighting pole of claim 1, further comprising at least one power cable connected in one end to said luminaire and routed through an inside of said structural support element.

9. The lighting pole of claim 1, further comprising at least one mounting bracket with which said at least one antenna is mounted to said structural support element.

10. The lighting pole of claim 1, wherein an outside of said at least one antenna forms part of an outside of said lighting pole.

11. The lighting pole of claim 1, further comprising a base adapted for mounting said lighting pole to ground, and a mid-pole section mounted on the base, wherein the structural support element extends at least between the mid-pole section and the luminaire.

12. The lighting pole of claim 11, wherein the structural support element extends through the mid-pole section and at least partly through the base.

13. The lighting pole of claim 1, further comprising at least one internet-of-things, IOT, space adapted to receive an IOT device.

14. The lighting pole of claim 13, further comprising at least one data cable having an end terminating in one end in said at least one IOT space and routed through an inside of the structural support element.

15. The lighting pole of claim 13, wherein an outside of said at least one IOT space forms part of an outside of said lighting pole.
